(19) United States
(12) Patent Application Publication
(10) Pub. No.: US 2015/0081564 A1
(43) Pub. Date: Mar. 19, 2015

(54) PRIVACY PRESERVING CONTENT ANALYSIS

(71) Applicant: International Business Machines Corporation, Armonk, NY (US)

(72) Inventors: JoAnn P. Brereton, Hawthorne, NY (US); Arun Hampapur, Norwalk, CT (US); Hongfei Li, Briarcliff Manor, NY (US); Robin Lougee, Yorktown Heights, NY (US); Buyue Qian, Ossining, NY (US)

(73) Assignee: International Business Machines Corporation, Armonk, NY (US)

(21) Appl. No.: 14/155,437

(22) Filed: Jan. 15, 2014

Related U.S. Application Data
(63) Continuation of application No. 14/027,388, filed on Sep. 16, 2013.

(51) Int. Cl. G06Q 10/06; H04L 29/06

(52) U.S. Cl. CPC G06Q 10/06; H04L 63/0428
USPC 705/51

(57) ABSTRACT

Embodiments relate to privacy preserving content analysis. A recoverable hash operation is performed on text information to produce hashed text information in a business-to-business system. The business-to-business system includes a business-to-business transaction gateway coupled to a plurality of enterprise computer systems. A non-recoverable hash operation is performed on numerical information to produce hashed numerical information in the business-to-business system. The hashed text information and the hashed numerical information are provided from the business-to-business transaction gateway to an analytics engine to perform encrypted content analysis. The text information and the numerical information are provided from one of the enterprise computer systems as a producer system to another of the enterprise computer systems as a consumer system through the business-to-business transaction gateway.

### CROSS-REFERENCE TO RELATED APPLICATIONS

This is a continuation application that claims the benefit of U.S. patent application Ser. No. 14/027,388 filed Sep. 16, 2013, the contents of which are incorporated by reference herein in their entirety.

### BACKGROUND

The present invention relates to business-to-business systems and, more specifically, to privacy preserving content analysis for a business-to-business transaction gateway in a business-to-business system.

Business-to-business systems provide a file gateway for businesses to exchange information, requests, and responses in a trusted environment. Applying analytics to transactions at a business-to-business file gateway can be challenging, since businesses typically do not want to expose sensitive data for analysis. For example, even though businesses may desire to acquire data from analytics, they also desire to keep identity and confidential information from being exposed to providers of third-party analytics engines that perform the analysis. Accordingly, these businesses must strike a balance between the amount and quality of sensitive data shared with analytics engine providers and risks associated with sharing sensitive data.

Business-to-business systems can use standardized information exchange formats for e-commerce. One example is electronic data interchange (EDI) to send orders to warehouses or perform order tracking. EDI data can be partitioned into an outside envelope with higher-level information and an internal envelope with lower-level information. EDI data is typically encoded but not encrypted when using standard translation, such as an X12-850 purchase order sent via EDI. Businesses seeking to employ analytics may desire to retain compatibility with industry standard protocols while also addressing concerns with maintaining confidentiality of the data with respect to third parties.

### SUMMARY

According to one embodiment of the present invention, a method for privacy preserving content analysis is provided. The method includes performing a recoverable hash operation on text information to produce hashed text information in a business-to-business system. The business-to-business system includes a business-to-business transaction gateway coupled to a plurality of enterprise computer systems. A non-recoverable hash operation is performed on numerical information to produce hashed numerical information in the business-to-business system. The hashed text information and the hashed numerical information are provided from the business-to-business transaction gateway to an analytics engine to perform encrypted content analysis. The text information and the numerical information are provided from one of the enterprise computer systems as a producer system to another of the enterprise computer systems as a consumer system through the business-to-business transaction gateway.

According to another embodiment of the present invention, a business-to-business system includes a business-to-business transaction gateway configured to communicate with a plurality of enterprise computer systems. A recoverable hash operation engine is configured to perform a recoverable hash operation on text information exchanged between the plurality of enterprise computer systems to produce hashed text information. A non-recoverable hash operation engine is configured to perform a non-recoverable hash operation on numerical information exchanged between the plurality of enterprise computer systems to produce hashed numerical information. An analytics engine interface is configured to provide the hashed text information and the hashed numerical information from the business-to-business transaction gateway to an analytics engine to perform encrypted content analysis.

According to a further embodiment of the present invention, a computer program product for privacy preserving content analysis is provided. The computer program product includes a storage medium embodied with machine-readable program instructions, which when executed by a computer causes the computer to implement a method. The method includes performing a recoverable hash operation on text information to produce hashed text information in a business-to-business system. The business-to-business system includes a business-to-business transaction gateway coupled to a plurality of enterprise computer systems. A non-recoverable hash operation is performed on numerical information to produce hashed numerical information in the business-to-business system. The hashed text information and the hashed numerical information are provided from the business-to-business transaction gateway to an analytics engine to perform encrypted content analysis. The text information and the numerical information are provided from one of the enterprise computer systems as a producer system to another of the enterprise computer systems as a consumer system through the business-to-business transaction gateway.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a business-to-business system upon which privacy preserving content analysis may be implemented according to an embodiment;

FIG. 2 depicts another view of a block diagram of the business-to-business system of FIG. 1 upon which privacy preserving content analysis may be implemented according to an embodiment;

FIG. 3 depicts an example of an electronic data interchange file format according to an embodiment;

FIG. 4 depicts a process for privacy preserving content analysis according to an embodiment; and

FIG. 5 depicts a computer system for privacy preserving content analysis according to an embodiment.

### DETAILED DESCRIPTION

Exemplary embodiments provide privacy preserving content analysis for a business-to-business transaction gateway in a business-to-business system. Embodiments can operate on electronic business transactions and data from multiple enterprise computer systems. In exemplary embodiments, hashing is used as an encryption tool and can be interpreted as a mapping of content to make human-readable information unreadable. Embodiments use different hashing methods for text and numerical values. For example, cryptographic hashing can be used for text information, while locality sensitive hashing can be used for arrays of numerical information. Arbitrary sized blocks of data that include text or numbers may be processed and returned as a fixed-size bit string as the hash value, i.e., encrypted data. In embodiments, a text string and its hash value have a one-to-one correspondence. The text hashing is a reversible and recoverable operation such that text is hashed to a bit string, and the text can be determined from the bit string. To more thoroughly protect numerical values, a non-recoverable hash operation is used such that even if a reverse hash is applied, the exact numerical values cannot be recovered.

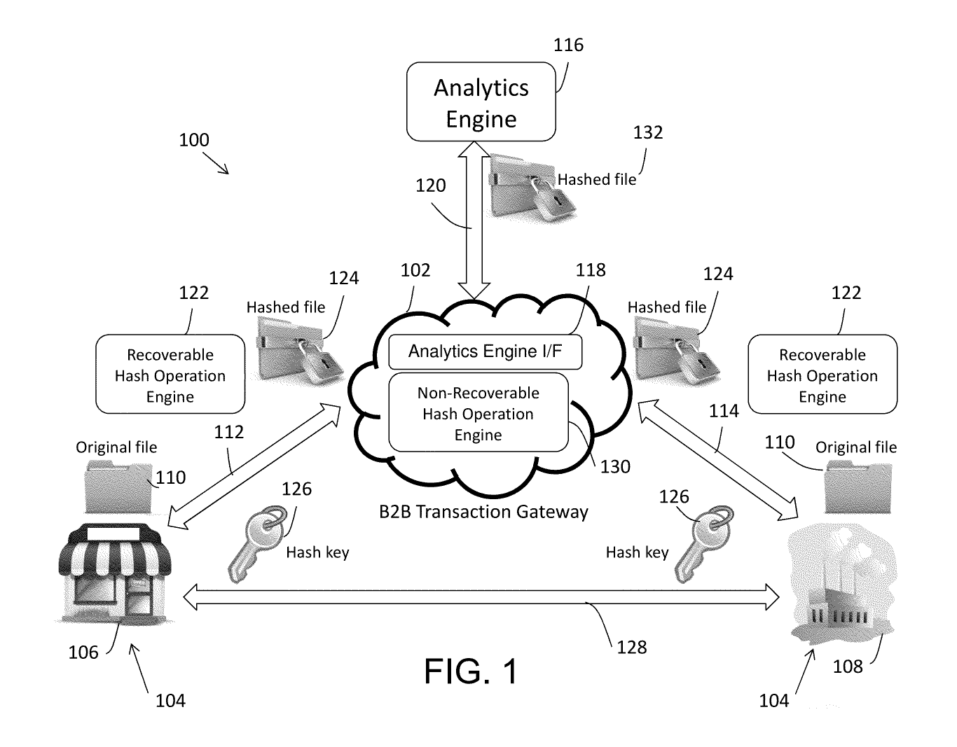

Turning now to FIG. 1, a business-to-business system 100 upon which privacy preserving content analysis may be implemented will now be described in an exemplary embodiment. Although described in terms of a business-to-business system 100 in FIG. 1, it will be understood that privacy preserving content analysis can be applied to any system configured to perform analytics while maintaining privacy of at least a portion of the data being analyzed. As depicted in FIG. 1, the business-to-business system 100 includes a business-to-business transaction gateway 102 configured to communicate with a plurality of enterprise computer systems 104. The business-to-business transaction gateway 102 may be a server computer system in a cloud or network system that securely routes data between the enterprise computer systems 104.

In the simplified example of FIG. 1, one of the enterprise computer systems 104 is a shop computer system 106 and another of the enterprise computer systems 104 is a factory computer system 108. When the shop computer system 106 is to place an order with the factory computer system 108, the shop computer system 106 generates an original file 110 that may be formatted as a purchase order including text information and numerical information. Accordingly, the shop computer system 106 acts as a producer system in this example and the factory computer system 108 acts as a consumer system with respect to data in the original file 110.

The shop computer system 106 interfaces with the business-to-business transaction gateway 102 through a business-to-business communication channel 112. The factory computer system 108 interfaces with the business-to-business transaction gateway 102 through a business-to-business communication channel 114. The business-to-business transaction gateway 102 also communicates with an analytics engine 116 through an analytics engine interface 118 and an analytics engine communication channel 120.

A recoverable hash operation engine 122 can be used in the business-to-business system 100 to convert the original file 110 into a hashed file 124. The shop computer system 106 and the factory computer system 108 can each include instances of the recoverable hash operation engine 122 such that they can each produce the hashed file 124 from the original file 110 and/or perform an inverse hash operation to produce the original file 110 from the hashed file 124. Where hashing is performed by the shop computer system 106 and the factory computer system 108, a hash key 126 can be exchanged on a communication channel 128 between the shop computer system 106 and the factory computer system 108. The hash key 126 can represent both a forward and an inverse hash key to hash or inverse hash files. Alternatively, the recoverable hash operation engine 122 can be incorporated in the business-to-business transaction gateway 102 such that hashing is only applied prior to sending data to the analytics engine 116.

In an exemplary embodiment, the recoverable hash operation engine 122 performs a recoverable hash operation on text information in the original file 110 to produce hashed text information. The recoverable hash operation may only be applied to a portion of text information in the original file that is considered sensitive or confidential. The recoverable hash operation engine 122 may apply a cryptographic hash to the original file 110 to produce a fixed-size hash value regardless of a number of characters in the text information. For example, a three character text string and a fifteen character text string may both be hashed into 160-bit values.

To further enhance privacy of content, the business-to-business transaction gateway 102 can include a non-recoverable hash operation engine 130. The non-recoverable hash operation engine 130 performs a non-recoverable hash operation on numerical information to produce hashed numerical information in the business-to-business system 100. The non-recoverable hash operation engine 130 can operate upon the hashed file 124 or the original file 110 to produce hashed file 132. The analytics engine interface 118 provides the hashed file 132, including hashed text information and hashed numerical information, from the business-to-business transaction gateway 102 to the analytics engine 116 to perform encrypted content analysis. Similar to the recoverable hash operation engine 122, the non-recoverable hash operation engine 130 may only operate on a portion of available data. Since the non-recoverable hash operation engine 130 only operates upon numerical information, it can use either the hashed file 124 or the original file 110 as input information.

In an exemplary embodiment, the non-recoverable hash operation performed by the non-recoverable hash operation engine 130 is a locality-sensitive hashing operation configured to substantially but not completely preserve locality properties of numerical information. The non-recoverable hash operation can include mapping input items based on the numerical information into a plurality of buckets to form a binary vector of the hashed numerical information having a reduced dimension relative to the numerical information as an approximation of the numerical information. A binary vector, b, can be formed for input items, x, according to equation 1.

$${b}_{x} = arg {max}_{b} \frac{{b}^{T} x}{‖ b ‖ ‖ x ‖} \\ s . t . b ∈ {\{ 0 , 1 \}}^{d} \qquad ( eqn . 1 )$$

Here, an arg max function provides a set of points for an argument for which the given function attains a maximum value for a transpose of b multiplied by x, divided by the absolute value of b multiplied by the absolute value of x. The underlying objective of equation 1 is to find a binary vector b that has the smallest (compared with all other binary vectors) angle distance to a real-valued vector x, such that original mathematical properties of the input data can be largely preserved after hashing. The value b is a binary element, i.e., 0 or 1, representing a bucket with a size defined by dimension d. The dimension d can be reduced from an original dimension of the input data to enhance security. For example, numerical information with a dimension d of about 100 may be considered more secure if reduced to about 80 and even more secure if reduced to about 60. A level of security may be a definable attribute when sending a file through the non-recoverable hash operation engine 130.

As one example of a simple greedy algorithm for the non-recoverable hash operation engine 130 to solve for locality sensitive hashing is provided as follows.

```
Input: Hyperplane normal vector w (non-negative)
Preprocess: Sort entries of w in ascending order
as w₍₁₎, . . . , w_{(d)}; Set bₖⁱ = 0 for ∀ j, k = 1, . . . , d;
αₖ = 0 for ∀ k = 1, . . . , d.
  1: for i = 1, . . . , d do
  2:  bₖⁱ = 1 for k = 1, . . . , i;
  3:  ${α}_{i} = \frac{{\sum }_{k = 1}^{i} {w}_{( k )}}{\sqrt{i}} ;$
  4: end for
  5: return b^{j″} corresponding to j* = arg minⱼ(αⱼ)
Postprocess: Reorder b w.r.t. the original ordering of w
Output: Binary vector b (most perpendicular to w)
```

Here, a cosine angle of vectors is used to maximize a cosine angle between vectors and minimize an angle between the vectors. In this example, w is a dimension reduced version of the input items of the numerical information that are sorted in ascending order. The binary vector b is reordered to align with original ordering of w and form hashed numerical information. This results in a distribution of b values that approximates that of the original numerical information, but if this is reversed, the actual values of the original numerical information cannot be recovered.

To further enhance privacy, additional operations can be performed on the hashed numerical information, b. Operations such as performing a rotation, rescale, and translation of the hashed numerical information maintain relative locality of distribution of the hashed numerical information while further modifying it. For example, consider a simple two dimensional plane where the hashed numerical information is represented as a collection of points forming a shape. If this shape is rescaled to enlarge or reduce the overall shape, the shape remains intact but the original distance between points in the two-dimensional space is not apparent from the rescaled shape itself. Further, the shape in two-dimensional space can be rotated about its central axis or about an origin of the two-dimensional space. Further, translation can shift a distance between the shape and the origin of the two-dimensional space as an additional modification.

The analytics engine 116 receives the hashed file 132 that includes hashed text information and the hashed numerical information after applying the recoverable and non-recoverable hash operations. The analytics engine 116 does not receive the hash key 126. While hashed details in the hashed file 132 remain private, the analytics engine 116 can perform analytics to look for patterns in the business-to-business system 100. For example, timing and frequency of messages or files can provide useful information and non-hashed data in the hashed file 132 can be directly accessible to the analytics engine 116. Additionally, since relative locality of data points may be maintained in the hashed file 132, this can also be used to approximate patterns without knowing the actual underlying details of the hashed data itself.

Although the business-to-business system 100 is depicted in FIG. 1 including a limited number of elements and connections between elements, the scope of embodiments is not so limited. There may be any number of instances of the business-to-business transaction gateway 102, enterprise computer systems 104, and analytics engine 116 supporting a number of file and hashing formats. Additional elements can be added, removed, or combined. Moreover, the analytics engine interface 118, recoverable hash operation engine 122, and the non-recoverable hash operation engine 130 can be distributed in multiple computer systems and can access other networks and/or data sources (not depicted). Additional features to ensure integrity of the files exchanged in the business-to-business system 100 of FIG. 1 can include application of redundant bits and self-correction coding in hashed messages including one or more of the hashed text information and the hashed numerical information.

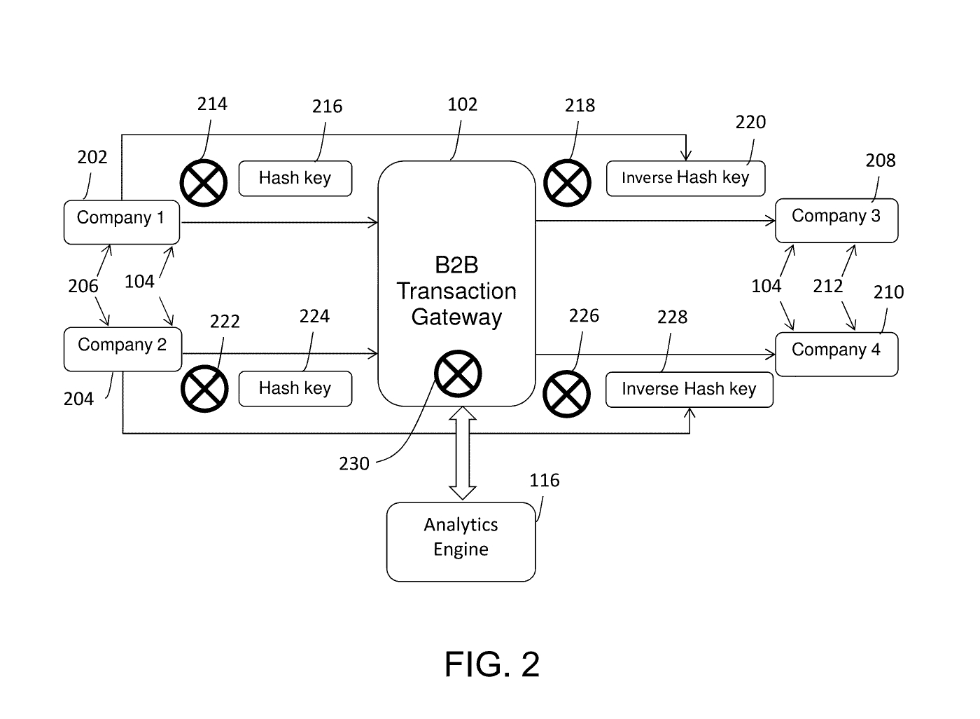

FIG. 2 depicts another view of a block diagram of the business-to-business system 100 of FIG. 1 upon which privacy preserving content analysis may be implemented according to an embodiment. In this example, the business-to-business transaction gateway 102 is coupled to a plurality of enterprise computer systems 104, where company enterprise computer system 202 and company enterprise computer system 204 are both producer systems 206, and company enterprise computer system 208 and company enterprise computer system 210 are both consumer systems 212. A recoverable hash operation 214 using a hash key 216 is performed on text information sent from the company enterprise computer system 202 to the business-to-business transaction gateway 102 to produce hashed text information. An inverse recoverable hash operation 218 can be applied to the hashed text information using an inverse hash key 220 provided by the company enterprise computer system 202, such that the company enterprise computer system 208 can receive and consume the text information in an unencrypted format.

Similarly, a recoverable hash operation 222 using a hash key 224 is performed on text information sent from the company enterprise computer system 204 to the business-to-business transaction gateway 102 to produce hashed text information. An inverse recoverable hash operation 226 can be applied to the hashed text information using an inverse hash key 228 provided by the company enterprise computer system 204, such that the company enterprise computer system 210 can receive and consume the text information in an unencrypted format. Before hashed text information from the producer systems 206 is provided to the analytics engine 116, a non-recoverable hash operation 230 is applied to numerical information to produce hashed numerical information. Therefore, the analytics engine 116 is configured to perform encrypted content analysis of the hashed text information and the hashed numerical information, thus resulting in privacy preserving content analysis.

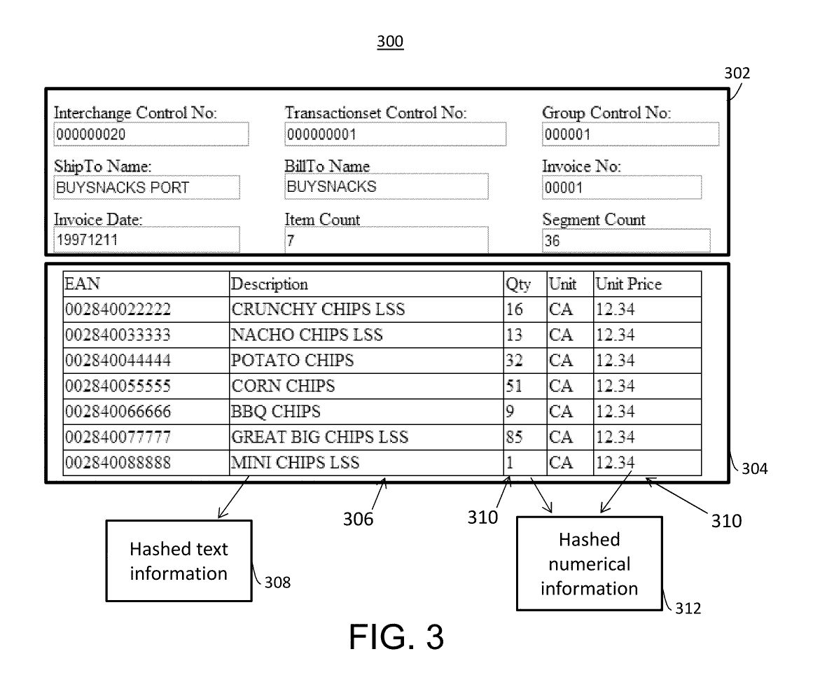

FIG. 3 depicts an example of an electronic data interchange file format 300 according to an embodiment. In the example of FIG. 3, the electronic data interchange file format 300 includes an outside envelope 302 and an inside envelope 304. A portion of data in the inside envelope 304 may be considered sensitive or confidential. A recoverable hash operation, such as the recoverable hash operation 214 or 222 of FIG. 2 may be applied by the recoverable hash operation engine 122 of FIG. 1 to text information 306 in the inside envelope 304 to produce hashed text information 308. Similarly, a non-recoverable hash operation, such as the non-recoverable hash operation 230 of FIG. 2 may be applied by the non-recoverable hash operation engine 130 of FIG. 1 to numerical information 310 in the inside envelope 304 to produce hashed numerical information 312. Accordingly, when the original file 110 of FIG. 1 complies with the electronic data interchange file format 300, the hashed file 124 of FIG. 1 may be equivalent to the electronic data interchange file format 300 with the text information 306 replaced by the hashed text information 308. The hashed file 132 of FIG. 1 may be equivalent to the electronic data interchange file format 300 with the text information 306 replaced by the hashed text information 308 and the numerical information 310 replaced by the hashed numerical information 312.

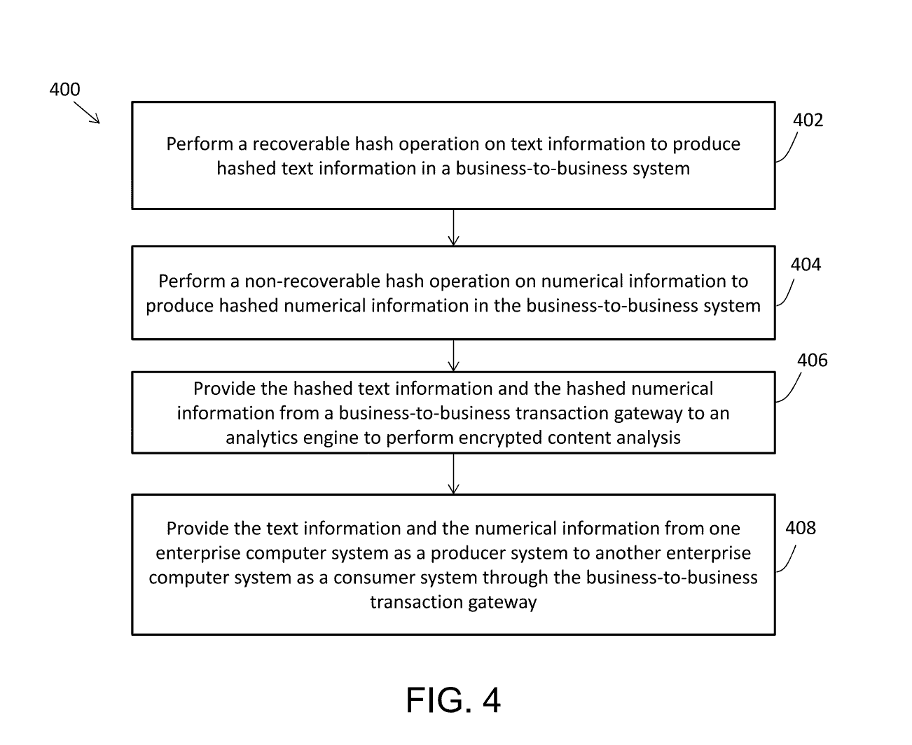

FIG. 4 depicts a process 400 for privacy preserving content analysis in accordance with an embodiment. The process 400 is described in reference to FIGS. 1-4 and need not be performed in the precise order as depicted in FIG. 4. The process 400 can be performed by the business-to-business system 100 of FIG. 1. More specifically, one or more computer processors in the business-to-business transaction gateway 102 and/or the enterprise computer systems 104 can implement the process 400. For simplicity, the process 400 is described relative to the recoverable hash operation 214 of FIG. 2 and the non-recoverable hash operation 230 of FIG. 2.

At block 402, a recoverable hash operation 214 is performed on text information 306 to produce hashed text information 308 in a business-to-business system 100. The recoverable hash operation 214 may be performed by the recoverable hash operation engine 122 of FIG. 1 in one of the enterprise computer systems 104 or in the business-to-business transaction gateway 102. The recoverable hash operation 214 can be a cryptographic hash configured to produce a fixed-size hash value regardless of a number of characters in the text information 306.

At block 404, a non-recoverable hash operation 230 is performed on numerical information 310 to produce hashed numerical information 312 in the business-to-business system 100. The non-recoverable hash operation 230 may be performed by a non-recoverable hash operation engine 130 in the business-to-business transaction gateway 102. The non-recoverable hash operation 230 can be a locality-sensitive hashing operation configured to substantially but not completely preserve locality properties of the numerical information 310. The non-recoverable hash operation 230 can include mapping input items based on the numerical information 310 into a plurality of buckets to form a binary vector of the hashed numerical information 312 having a reduced dimension relative to the numerical information 310 as an approximation of the numerical information 310. The non-recoverable hash operation 230 can also include performing a rotation, rescale, and translation of the hashed numerical information 312.

At block 406, the hashed text information 308 and the hashed numerical information 312 are provided from the business-to-business transaction gateway 102 to an analytics engine 116 to perform encrypted content analysis. The hashed text information 308 and the hashed numerical information 312 may be provided in the hashed file 132 via the analytics engine interface 118.

At block 408, the text information 306 and the numerical information 310 are provided from one of the enterprise computer systems 104 as a producer system 206 to another of the enterprise computer systems 104 as a consumer system 212 through the business-to-business transaction gateway 102. The text information 306 may be provided based on applying the inverse recoverable hash operation 218 to the hashed text information 308. Data exchanged between the enterprise computer systems 104 can be in an electronic data interchange file format, such as electronic data interchange file format 300 including an outside envelope 302 and an inside envelope 304. The recoverable hash operation 214 and the non-recoverable hash operation 230 can be applied to at least a portion of data in the inside envelope 304.

As previously described, in various embodiments the recoverable hash operation 214 can be performed by different elements in the business-to-business system 100. In one example, the recoverable hash operation 214 is performed by a producer system 206 using a hash key 216, where the hash key 216 (or inverse hash key 220) is provided to the consumer system 212. The non-recoverable hash operation 230 may be performed by the business-to-business transaction gateway 102, and the hashed text information 308 and the numerical information 310 are provided from the business-to-business transaction gateway 102 to the consumer system 212. An inverse recoverable hash operation 218 can be applied by the consumer system 212 using the hash key 216 (or inverse hash key 220) to recover the text information 306. In another embodiment, the business-to-business transaction gateway 102 performs both the recoverable hash operation 214 and the non-recoverable hash operation 230.

To further enhance error tolerance, redundant bits and self-correction coding can be included in hashed messages including one or more of the hashed text information 308 and the hashed numerical information 312.

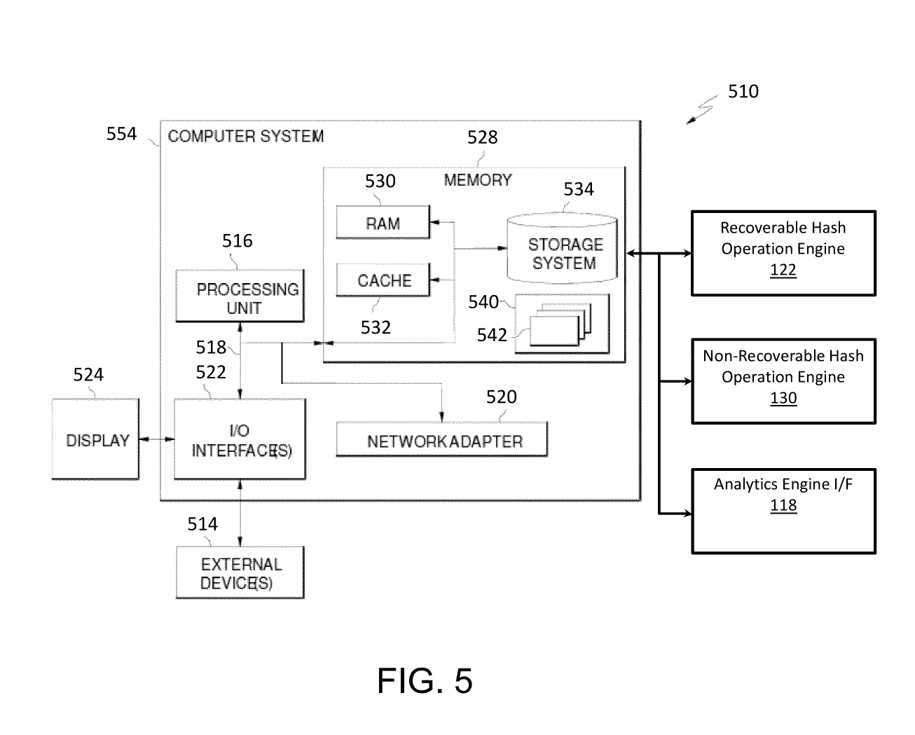

Referring now to FIG. 5, a schematic of an example of a computer system 554 in an environment 510 is shown. The computer system 554 is only one example of a suitable computer system and is not intended to suggest any limitation as to the scope of use or functionality of embodiments described herein. Regardless, computer system 554 is capable of being implemented and/or performing any of the functionality set forth hereinabove. The computer system 554 may be an embodiment of the business-to-business transaction gateway 102 of FIG. 1 and/or one of the enterprise computer systems 104 of FIG. 1.

In the environment 510, the computer system 554 is operational with numerous other general purpose or special purpose computing systems or configurations. Examples of well-known computing systems, environments, and/or configurations that may be suitable as embodiments of the computer system 554 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 554 may be described in the general context of computer system-executable instructions, such as program modules, being executed by one or more processors of the computer system 554. Generally, program modules may include routines, programs, objects, components, logic, data structures, and so on that perform particular tasks or implement particular abstract data types. Computer system 554 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 5, computer system 554 is shown in the form of a general-purpose computing device. The components of computer system 554 may include, but are not limited to, one or more computer processing circuits (e.g., processors) or processing units 516, a system memory 528, and a bus 518 that couples various system components including system memory 528 to processor 516. When embodied as the business-to-business transaction gateway 102 of FIG. 1, the processor 516 is communicatively coupled to the enterprise computer systems 104 of FIG. 1 and the analytics engine 116 of FIG. 1 via network adapter 520.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 554 typically includes a variety of computer system readable media. Such media may be any available media that is accessible by computer system 554, and it includes both volatile and non-volatile media, removable and non-removable media.

System memory 528 can include computer system readable media in the form of volatile memory, such as random access memory (RAM) 530 and/or cache memory 532. Computer system 554 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein. Example application programs or modules are depicted in FIG. 5 as the recoverable hash operation engine 122, the non-recoverable hash operation engine 130, and the analytics engine interface 118. Although the recoverable hash operation engine 122, the non-recoverable hash operation engine 130, and the analytics engine interface 118 are depicted separately, they can be combined and/or incorporated in any application or module. The recoverable hash operation engine 122, the non-recoverable hash operation engine 130, and the analytics engine interface 118 can be stored directly in the memory 528 or can be accessible by the processor 516 from a location external to the computer system 554.

Computer system 554 may also communicate with one or more external devices 514 such as a keyboard, a pointing device, a display device 524, etc.; one or more devices that enable a user to interact with computer system 554; and/or any devices (e.g., network card, modem, etc.) that enable computer system 554 to communicate with one or more other computing devices. Such communication can occur via input/output (I/O) interfaces 522. Still yet, computer system 554 can communicate with one or more networks such as a local area network (LAN), a general wide area network (WAN), and/or a public network (e.g., the Internet) via network adapter 520. As depicted, network adapter 520 communicates with the other components of computer system 554 via bus 518. It should be understood that although not shown, other hardware and/or software components could be used in conjunction with computer system 554. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include privacy preserving content analysis for a business-to-business transaction gateway in a business-to-business system. Sensitive information is selectively encrypted using a recoverable hash operation on text information and a non-recoverable hash operation on numerical information. Encryption enables performance of analytics or data sets that include sensitive data, while ensuring that the sensitive data remains private. Incorporating the hashing into a business-to-business transaction gateway results in little to no impact for enterprise computer systems communicating via the business-to-business transaction gateway. Redundant bits and self-correcting codes, e.g., error correcting codes (ECC), tolerate and correct transmission errors and verify integrity of hashed messages.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for privacy preserving content analysis, comprising:
performing a recoverable hash operation on text information to produce hashed text information in a business-to-business system, the business-to-business system comprising a business-to-business transaction gateway coupled to a plurality of enterprise computer systems;
performing a non-recoverable hash operation on numerical information to produce hashed numerical information in the business-to-business system;
providing the hashed text information and the hashed numerical information from the business-to-business transaction gateway to an analytics engine to perform encrypted content analysis; and
providing the text information and the numerical information from one of the enterprise computer systems as a producer system to another of the enterprise computer systems as a consumer system through the business-to-business transaction gateway.

2. The method of claim 1, wherein the non-recoverable hash operation is a locality-sensitive hashing operation configured to substantially but not completely preserve locality properties of the numerical information.

3. The method of claim 2, wherein the non-recoverable hash operation further comprises:
mapping input items based on the numerical information into a plurality of buckets to form a binary vector of the hashed numerical information having a reduced dimension relative to the numerical information as an approximation of the numerical information.

4. The method of claim 3, wherein the non-recoverable hash operation further comprises:
performing a rotation, rescale, and translation of the hashed numerical information.

5. The method of claim 1, wherein data exchanged between the enterprise computer systems is in an electronic data interchange file format comprising an outside envelope and an inside envelope, and the recoverable hash operation and the non-recoverable hash operation are applied to at least a portion of data in the inside envelope.

6. The method of claim 1, further comprising:
performing the recoverable hash operation by the producer system using a hash key;
providing the hash key to the consumer system;
performing the non-recoverable hash operation by the business-to-business transaction gateway;
providing the hashed text information and the numerical information from the business-to-business transaction gateway to the consumer system; and
applying an inverse hash operation by the consumer system using the hash key to recover the text information.

7. The method of claim 1, wherein the business-to-business transaction gateway performs the recoverable hash operation and the non-recoverable hash operation.

8. The method of claim 1, wherein the recoverable hash operation is a cryptographic hash configured to produce a fixed-size hash value regardless of a number of characters in the text information, and further comprising including redundant bits and self-correction coding in hashed messages comprising one or more of the hashed text information and the hashed numerical information.
